(19) United States
(12) Patent Application Publication
(10) Pub. No.: US 2004/0161611 A1
(43) Pub. Date: Aug. 19, 2004

(54) Laminated composite material and method for the production thereof

(76) Inventors: Klaus Mueller, Sulzbach (DE); Klaus Klemm, Oberelsbach (DE)

Correspondence Address: KEIL & WEINKAUF, 1350 CONNECTICUT AVENUE, N.W., WASHINGTON, DC, 20036, US

(21) Appl. No.: 10/484,149

(22) PCT Filed: Jul. 16, 2002
(86) PCT No.: PCT/EP02/07898

(30) Foreign Application Priority Data
Jul. 26, 2001 (JP) 101 36 125.4

(51) Int. Cl. B32B 15/08

(52) U.S. Cl. 428/412; 156/245

(57) ABSTRACT

The present invention relates to a layered composite material which encompasses at least

a) a polyolefin backing layer,

b) an intermediate ply arranged on the backing layer and comprising a thermoplastic polymer material,

c) a heat-cured layer arranged on the intermediate ply, and

d) an outer layer arranged on the heat-cured layer and composed of thermoplastic.

The thermoplastic in the outer layer here has been selected from the group consisting of polycarbonates, acrylonitrile-butadiene-styrene copolymers, polybutylene terephthalates, and polyesters, and derivatives and mixtures of these. The layered composite material has excellent properties when used for producing three-dimensional moldings in the elecrical, construction, or automotive industry, with very good reproduction of detail and excellent surface properties.

The present invention relates to a novel layered composite material with a multilayer structure, and also to a process for producing this layered composite material.

Layered composite materials based on plastics, and moldings made from these layered composite materials, are widely used for a very wide variety of technical purposes. For example, a wide variety of moldings, frequently decorative, is used in the electrical, electronics, and automotive industries, examples of products manufactured from these composite materials being panel sections, keyboards, switches, instrument panels, and parts of the internal trim of motor vehicles, etc.

The abovementioned moldings often have an outer layer or an outer film, made from polycarbonate, for example. A particular feature of polycarbonate outer films is that they permit the surface of the molding to be of high optical quality, and also that they have advantageous properties with regard to scratch resistance, impact resistance, transparency, etc.

Plastic films of this type, in particular colored films and light-scattering films, have been known for a long time, examples of their use being in automotive construction for the production of front panels, or of internally illuminated switch covers or identification labeling, e.g. for operating switches of motor vehicle heating or air-conditioning systems. The symbols and/or inscriptions are applied in a manner known per se, for example by screen-printing or multiple screen-printing processes.

There is usually an adhesive bond between the base and the directly exposed or visible surface, i.e. the outer layer of the molding or of the composite material. The base, or the under- or backing layer provides the structural strength or dimensional stability needed by the three-dimensionally shaped molding.

The composite materials known hitherto, and in particular used in the electrical, electronics, and automotive industries, and, for example, having decorative surfaces with the required properties, are usually composed of a layer of film, e.g. made from polycarbonate (PC) or from acrylonitrile-butadiene-styrene copolymers (ABS copolymers), and of a backing layer made from the same material, i.e. likewise from PC or ABS copolymer. When composite materials of this type are produced, the outer film or light-scattering film, which, where appropriate, has been decorated with color or some other effect in a preceding operation, is bonded to the backing material by heat treatment, for example, or the backing material is in-mold coated onto the reverse side of the outer film by an injection molding process.

However, composite materials of this type used hitherto have serious disadvantages. The fact that identical materials have to be used in producing the composite material described above or the resultant moldings, or for ensuring a secure bond between backing and outer film, results in three-dimensional moldings with very high weight. This is attributable to the relatively high density of the backing materials used, for example polycarbonate. The high weight of the backing material and therefore of the entire composite material is particularly disadvantageous in automotive construction, since it has an adverse effect on the gasoline consumption of the motor vehicle, for example, and therefore reduces cost-effectiveness. In addition, the known composite materials made from PC and ABS copolymers remain highly unsatisfactory with regard to their chemicals resistance and their recyclability when compared with other materials.

Another disadvantage of the conventional composite materials is the relatively high price of the backing materials used. In addition, the materials used as backing material, polycarbonates for example, have less capability than other thermoplastic polymers, such as polyethylene or propylene, with regard to modification of processing properties.

There is therefore an urgent need for novel, qualitatively improved composite materials which on the one hand have the advantageous properties in relation to surface design, scratch resistance, UV resistance, etc., but at the same time overcome, rather than incorporate, the disadvantages of the composite materials of the prior art. In particular, it would be extremely desirable for numerous industrial applications, and in particular for the automotive industry, to have appropriate composite materials available which, while having the required mechanical properties, are less expensive and lighter in weight.

It was therefore an object of the present invention to eliminate the disadvantages described and provide a qualitatively improved composite material which has very good capability for two- and three-dimensional shaping, and has very high mechanical stability due to secure adhesion between the layers. A particular object of the present invention was to provide a composite material which has an outer polymer layer known per se with the known advantageous properties in relation to surface design, scratch resistance, UV resistance, etc., but whose total weight is smaller, and whose production is less expensive and therefore more cost-effective. These objects imply a need to modify or replace the backing material conventionally used or the conventional composition of the known layered composite material.

The abovementioned objects are achieved by providing a layered composite material whose characterizing features are that the composite material encompasses:

a) a polyolefin backing layer,

b) an intermediate ply arranged on the backing layer and comprising a thermoplastic polymer material,

c) a heat-cured layer arranged on the intermediate ply, and

d) an outer layer arranged on the heat-cured layer and composed of thermoplastic, where the thermoplastic in the outer layer has been selected from the group consisting of polycarbonates, acrylonitrile-butadiene-styrene copolymers, polybutylene terephthalates, polyesters, and derivatives and mixtures of the abovementioned materials.

Particularly advantageous embodiments of the present invention are defined in the subclaims.

Surprisingly, it has been found that the inventive arrangement of layers or combination of materials within the composite material ensures excellent adhesion between the layers, thus permitting the binding of thermoplastics selected from the group consisting of polycarbonates, acrylonitrile-butadiene-styrene copolymers, polybutylene terephthalates, polyesters, and derivatives and mixtures of the abovementioned materials to a polyolefin backing layer. This means that there is absolutely no need to use the backing material used in the composite materials known hitherto, with the abovementioned disadvantageous properties. The composite material of the invention and the moldings produced therefrom have very high mechanical stability and the desired surface properties. In addition, they are also markedly lighter in weight than the corresponding moldings known hitherto. Since the backing material of the inventive multilayer composite encompasses polyolefin materials and particularly preferably polypropylene instead of, for example, polycarbonate, the production of the composite material of the invention is also markedly less expensive and more cost-effective.

The outer layer of the composite material of the invention may be a commercially available polymer film made from a thermoplastic, the polymer having been selected from the group consisting of polycarbonates, acrylonitrile-butadiene-styrene copolymers, polybutylene terephthalates, polyesters, and derivatives and mixtures of the abovementioned materials.

In one particularly preferred embodiment of the present invention, the inventive outer layer arranged on the heat-cured layer and made from thermoplastic is a commercially available thermoplastic film, preferably a printed, colored, and/or otherwise decorated film, particularly preferably a polycarbonate film (e.g. Makrofol/Bayfol from Bayer, Leverkusen, Germany).

It is particularly preferable for the outer layer to comprise polycarbonate or to be a polycarbonate film.

For the purposes of the present invention, polycarbonates encompass, for example, thermoplastic polyesters of carbonic acid with aromatic bisphenols, such as bisphenol A. They may form the outer layer alone or in a mixture with other plastics compatible therewith. Examples of other compatible plastics encompass certain polyesters. Their proportions in the mixture may be up to 90% by weight, preferably up to 50% by weight. Compatibility is present when the mixture in the form of a film is clear or almost clear and transparent.

Other outer layer materials or polymer materials preferred according to the invention are polyesters, in particular aromatic polyesters, such as polyalkylene terephthalates.

Other outer layer materials or polymer materials used and likewise preferred are copolymers of styrene which preferably contain up to 35% by weight, in particular up to 20% by weight, of copolymerized acrylonitrile and up to 35% by weight, in particular up to 30% by weight, of copolymerized butadiene.

The inventive outer layer made from thermoplastic, hereinafter also termed outer film or light-scattering film, preferably has a decoration applied by printing or metallizing. The good printability of, for example, polycarbonate films permits in principle the application of one or more color layers or of the decorative effect, preferably on the underside of the film, so that the color or the decorative effect remains visible through the transparent layer of film after lamination and at the same time has protection from abrasion or other damage. In one preferred embodiment, therefore, the outer layer has been manufactured from a translucent or transparent material.

Processes known per se are used for decoration or for application of color layers to the, for example, translucent, outer layer or outer film. It is usual for particular color effects to be created, or particular identification markings produced, on the outer film with the aid of screen-printing processes, by applying one or more coatings of ink, where appropriate translucent ink. Furthermore, it is possible to embed the color layer between two layers of film in order to separate the color layer from the heat-cured layer. This two-ply structure is again known and is achieved industrially using Makrofol/Bayfol polymer films.

In the present invention it is particularly preferable to use films or layers with a thickness of from 50 to 800 μm, particularly preferably from 100 to 400 μm.

The composite material of the invention also encompasses at least one heat-cured layer bonded to the outer layer.

In one particularly preferred embodiment, the heat-cured layer encompasses a thermoset material which is crosslinked by the action of pressure or heat during the production of the layered composite material.

In another preferred embodiment, the heat-cured layer comprises resin, preferably acrylate resin, phenolic resin, urea resin, and/or melamine resin.

It is preferable for the degree of resinification in the heat-cured layer to be up to 300%. A degree of resinification of 300% means that practically the entire surface of the layer has multiple resin coating. A particularly preferred degree of resinification according to the invention is from 50 to 300%, while from 70 to 200% is especially preferred, and from 100 to 150% is most preferred.

The weight of the heat-cured layer, which preferably encompasses a resin, is preferably from 10 to 200 g/m², in particular from 15 to 150 g/m², and with particular preference from 30 to 80 g/m².

In one particularly preferred embodiment of the present invention, the heat-cured layer used comprises a resin-saturated nonwoven, fabric, or paper, or a resin-saturated film made from a thermoplastic. Resins suitable for this purpose encompass acrylate resins, phenolic resins, urea resins, and melamine resins.

Alongside the heat-cured layer and the outer layer arranged on the heat-cured layer and made from thermoplastic, the composite material of the invention also encompasses at least one intermediate ply which comprises at least one thermoplastic polymer material.

The preferred arrangement of the intermediate ply provided according to the invention is between the heat-cured layer and the polyolefin backing layer.

In one preferred embodiment of the present invention, the intermediate ply arranged on the backing layer comprises a thermoplastic polymer material, preferably a polymer material selected from the group consisting of polypropylene, polyethylene, polymers of styrene, polyoxymethylene, polyvinyl chloride, polysulfones, polyether ketones, polyesters, polycycloolefins, polyacrylates, polymethacrylates, polyamides, polycarbonate, polyurethanes, polyacetals, and polybutylene terephthalate, and is more preferably a polypropylene, and is particularly preferably a polypropylene with a melting point below 165° C.

It is moreover preferable that the intermediate ply arranged on the backing layer encompasses a resin-saturated paper, nonwoven, or a fabric made from thermoplastic, or a film made from thermoplastic.

In another preferred embodiment, the intermediate ply is in the form of a thin film made from thermoplastic, or in the form of paper, or else in the form of a thin nonwoven, or a fabric made from thermoplastic with a thickness in the range from 0.001 to 1.0 mm, in particular from 0.005 to 0.3 mm.

In a preferred embodiment of the invention, the weight of the intermediate ply is from 10 to 150 g/m², more preferably from 15 to 120 g/m², and particularly preferably from 30 to 80 g/m².

In another preferred embodiment of the present invention, the materials used for the intermediate ply comprise polyolefins, such as polyethylene or polypropylene, use of the latter being preferred. For the purposes of the present invention, the term polypropylene applies to both homo- and copolymers of propylene.

In another particularly preferred embodiment of the present invention, the intermediate layer uses polypropylene which can be prepared by polymerization in the presence of a Ziegler-Natta catalyst system.

The preparation of polypropylene by means of a Ziegler-Natta catalyst system usually takes place in the presence of catalyst systems which comprise not only a titanium-containing solid component a) but also cocatalysts in the form of organoaluminum compounds b) and electron-donor compounds c).

Usual Ziegler-Natta catalyst systems comprise a titanium-containing solid component, inter alia halides or alcoholates of tri- or tetravalent titanium, and also a halogen-containing magnesium compound, inorganic oxides, e.g. silica gel, as substrates, and also electron-donor compounds. These are in particular carboxylic acid derivatives, or else ketones, ethers, alcohols or organosilicon compounds.

The titanium-containing solid component may be prepared by methods known per se. The process known from DE-A 195 29 240 is preferably used.

Suitable aluminum compounds b), besides trialkylaluminum compounds, are those compounds in which one alkyl group has been replaced by an alkoxy group or by a halogen atom, for example by chlorine or bromine. The alkyl groups may be identical or differ from one another and may be linear or branched. Preference is given to the use of trialkylaluminum compounds having alkyl groups each of which has from 1 to 8 carbon atoms, for example trimethylaluminum, triethylaluminum, triisobutylaluminum, trioctylaluminum or methyldiethylaluminum, or mixtures of these.

Other cocatalysts used, besides the aluminum compound b), are generally electron-donor compounds c), such as mono- or polybasic carboxylic acids, carboxylic anhydrides or carboxylic esters, or else ketones, ethers, alcohols or lactones, or else organophosphorus or organosilicon compounds. The electron-donor compounds c) may be identical with or different from the electron-donor compounds used to prepare the titanium-containing solid component a).

Instead of using Ziegler-Natta catalyst systems it is also possible to prepare polypropylene by using metallocene compounds and, respectively, metal complexes active in polymerization. Polymerization of propylene using the abovementioned catalyst systems gives polypropylene products which have advantageous properties for the composite materials of the invention. For example, the comparatively low melting point of below 165° C. is advantageous in these polypropylene materials, in particular during processing. An example of a particularly suitable polypropylene according to the invention is obtainable as ®Metocene from BASELL GmbH.

For the purposes of the present invention, metallocenes are complex compounds made from metals of transition groups of the Periodic Table with organic ligands, giving effective catalyst systems when combined with metallocenium-ion-forming compounds. When used to prepare polypropylene, the metallocene complexes in the catalyst system are generally supported in supported form. The supports used often comprise inorganic oxides, but use may also be made of organic supports in the form of polymers such as polyolefins. Preference is given to the inorganic oxides described above, which are also used to prepare the titanium-containing solid component a).

The central atoms in the metallocenes usually used are titanium, zirconium or hafnium, preferably zirconium. The central atom generally has a bonding via a π bond to at least one, generally substituted, cyclopentadienyl group, and also to other substituents. The other substituents may be halogens, hydrogen or organic radicals, preferably fluorine, chlorine, bromine or iodine or C₁-C₁₀-alkyl. The cyclopentadienyl group may also be a constituent of an appropriate heteroaromatic system.

Preferred metallocenes contain central atoms bonded via two identical or different π-bonds to two substituted cyclopentadienyl groups, and particular preference is given to those in which substituents of the cyclopentadienyl groups have bonding to both cyclopentadienyl groups. Particular preference is given to complexes whose substituted or unsubstituted cyclopentadienyl groups also have substitution by cyclic groups at two adjacent carbon atoms, where the cyclic groups may also have been integrated within a heteroaromatic system.

Other preferred metallocenes are those which contain only one substituted or unsubstituted cyclopentadienyl group which, however, has substitution by at least one radical also bonded to the central atom.

Examples of suitable metallocene compounds are:

ethylenebis(indenyl)zirconium dichloride,

ethylenebis(tetrahydroindenyl)zirconium dichloride,

diphenylmethylene-9-fluorenylcyclopentadienylzirconium dichloride,

dimethylsilanediylbis(-3-tert-butyl-5-methylcyclopentadienyl)zirconium dichloride,

dimethylsilanediyl(2-methyl-4-azapentalene)(2-methyl-4(4′-methylphenyl)indenyl)zirconium dichloride,

dimethylsilanediyl(2-methyl-4-thiapentalene)(2-ethyl-4(4′-tertbutylphenyl)indenyl)zirconium dichloride,

ethanediyl(2-ethyl-4-azapentalene)(2-ethyl-4(4′-tert-butylphenyl)indenyl)zirconium dichloride,

dimethylsilanediylbis(2-methyl-4-azapentalene)zirconium dichloride,

dimethylsilanediylbis(2-methyl-4-thiapentalene)zirconium dichloride,

dimethylsilanediylbis(2-methylindenyl)zirconium dichloride,

dimethylsilanediylbis(2-methylbenzindenyl)zirconium dichloride,

dimethylsilanediylbis(2-methyl-4-phenylindenyl)zirconium dichloride,

dimethylsilanediylbis(2-methyl-4-naphthylindenyl)zirconium dichloride,

dimethylsilanediylbis(2-methyl-4-isopropylindenyl)zirconium dichloride oder

dimethylsilanediylbis(2-methyl-4,6-diisopropylindenyl)zirconium dichloride,

and also the corresponding dimethylzirconium compounds.

The metallocene compounds are either known or can be obtained by known methods. It is also possible to use mixtures of metallocene compounds of this type for catalysis, or to use the metallocene complexes as described in EP-A 416 815.

The metallocene catalyst systems also comprise metallocenium-ion-forming compounds. Those suitable are strong, neutral Lewis acids, ionic compounds with Lewis acid cations or ionic compounds with Brönsted acids as cation. Examples of these are tris(pentafluorophenyl)borane, tetrakis(pentafluorophenyl)borate or salts of N,N-dimethylanilinium. Other suitable metallocenium-ion-forming compounds are open-chain or cyclic aluminoxane compounds. These are usually prepared by reacting trialkylaluminum compounds with water and are generally mixures of linear and also cyclic chain molecules of various lengths.

The metallocene catalyst systems may moreover comprise organometallic compounds of the metals of the 1st, 2nd or 3rd main group of the Periodic Table, for example n-butyllithium, n-butyl-n-octylmagnesium or triisobutylaluminum, triethylaluminum or trimethylaluminum.

The polypropylenes used for the substrate layer are prepared by polymerization in at least one reaction zone, or else frequently in two or even more reaction zones arranged in series (a reactor cascade), in the gas phase, in suspension or in a liquid phase (bulk). The usual reactors for polymerizing C₂-C₈ 1-alkenes may be used. Examples of suitable reactors are continuous stirred-tank reactors, loop reactors and fluidized-bed reactors. The size of the reactors is not significant for the process of the invention. It depends on the output which is to be achieved in the individual reaction zone(s).

Use is in particular made of fluidized-bed reactors or else horizontally or vertically agitated powder-bed reactors. The reaction bed is generally composed of the polymer made from C₂-C₈ 1-alkenes which is polymerized in the respective reactor.

The polypropylenes are prepared by polymerization under conventional reaction conditions at from 40 to 120° C., in particular from 50 bis 100° C., and at pressures of from 10 to 100 bar, in particular from 20 to 50 bar.

According to the invention, suitable materials for the intermediate ply also encompass copolymers, preferably copolymers of propylene, containing subordinate amounts of monomers copolymerizable with propylene, for example C₂-C₈ 1-alkenes, such as ethylene, 1-butene, 1-pentene, or 1-hexene. It is also possible to use two or more different comonomers.

Particularly suitable materials for the intermediate ply of the invention encompass homopolymers of propylene or copolymers of propylene with up to 50% of other 1-alkenes which can be copolymerized and have up to 8 carbon atoms. These copolymers of propylene are random copolymers of block or impact copolymers. If the copolymers of propylene have a random structure, they generally contain up to 15% by weight, preferably up to 6% by weight, of other 1-alkenes having up to 8 carbon atoms, in particular ethylene, 1-butene, or a mixture of ethylene and 1-butene.

Block or impact copolymers of propylene are polymers for which the first stage consists in preparing a propylene homopolymer or a random copolymer of propylene with up to 15% by weight, preferably up to 6% by weight, of other 1-alkenes having up to 8 carbon atoms, and the second stage then consists in preparing a propylene-ethylene copolymer having an ethylene content of from 15 to 80% by weight, which may also contain other C₄-C₈ 1-alkenes, by polymerization onto the (co)polymer prepared in the first stage. The amount of the propylene-ethylene copolymer polymerized onto the polymer prepared in the first stage is generally such that the copolymer produced in the second stage makes up from 3 to 60% of the final product.

Alongside the outer layer, the heat-cured layer, and the intermediate ply described above, the composite material of the invention encompasses a backing material which comprises at least one polyolefin. The polyolefin backing layer of the present invention comprises at least one olefin homo- or copolymer, or else a terpolymer (1-butene), and therefore comprises thermoplastic polymer materials.

In one particularly preferred embodiment, the backing material comprises a polyolefin from the group consisting of polypropylene, polyethylene, and copolymers of ethylene and propylene with α-olefins, and terpolymers, preferably with poly-1-butene, and particularly preferably polypropylene.

In principle, any homo- or copolymer of propylene is suitable. Examples of polypropylenes suitable according to the invention have been described in detail at an earlier stage above in the context of the intermediate ply provided according to the invention.

In another preferred embodiment, the polyolefin backing material comprises soft components, which are also termed “soft-touch stabilizers”. They give the polyolefin material or the polypropylene certain plasto-elastic properties, these being desirable in automotive construction, for example. Examples of suitable soft-touch stabilizers and corresponding polypropylene materials are mixtures of polypropylene and ethylene-propylene copolymers with an ethylene-propylene copolymer content of from 60 to 70%. These mixtures are preferably prepared in a reactor cascade where the first reactor polymerizes propylene and the subsequent reactor polymerizes a propylene/ethylene mixture which may also comprise other monomers. Examples of materials of this type are prepared using the Basell polyolefins ®Catalloy process and marketed as ®Adflex or ®Hifax.

All of the abovementioned layers or materials may comprise from 0 to 60% by weight, preferably from 1 to 50% by weight, particularly preferably from 10 to 40% by weight, based on the total weight of the respective layer, of additives or reinforcing fillers, e.g. barium sulfate, magnesium hydroxide, talc, wood, flax, chalk, glass fibers, coated glass fibers, long or short glass fibers, glass beads, or mixtures of these. In addition, the usual additives, for example light stabilizers, UV stabilizers, heat stabilizers, pigments, carbon black, lubricants, flame retardants, blowing agents, soft components, such as ethylene-propylene elastomers, and the like may also be added to the materials or layers, the amounts of these being the usual amounts required in each case.

In another preferred embodiment, the total thickness of the layered composite material of the invention is from 1 to 100 mm, the backing layer preferably providing at least 80% of the total thickness.

The present invention also provides a process for producing the layered composite material of the invention, or a three-dimensional molding from the layered composite material of the invention.

The present invention provides a process for producing the composite material of the invention or a three-dimensional molding made from the composite material of the invention, and encompassing the following steps:

a) bonding the heat-cured layer and the intermediate ply by heat treatment of these layers in a mold,

b) applying the outer layer made from thermoplastic,

c) applying the polyolefin backing layer to the intermediate ply,

the steps a), b) and/or c) taking place simultaneously or in succession, where the three-dimensional shaping takes place prior to and/or during and/or after step c).

One process embodiment preferred according to the invention provides that the intermediate ply and the heat-cured layer, where appropriate together with the outer layer made from thermoplastic, are bonded by heat treatment in a mold. This process may introduce the intermediate ply, the heat-cured layer and, where appropriate, the outer layer made from thermoplastic either separately in the form of individual film(s) into the mold, i.e. without preliminary pressing, or else together, for example in the form of a prefabricated, preferably flexible laminate.

Another preferred embodiment provides that the intermediate ply and the heat-cured layer are bonded to one another by heat treatment in a mold, and that the step b), i.e. the application of the outer layer made from thermoplastic, takes place in a separate, subsequent step of the process. For example, the outer layer made from thermoplastic may be applied by injection molding. It is particularly preferable for the outer layer made from thermoplastic, and the backing layer, to be applied using what is known as the 2C process, in which the composite obtained as an intermediate made from heat-cured layer and intermediate ply is given an in-mold coating on one side with one of the components in an injection molding process, while the second component is applied on the opposite side.

In one embodiment preferred according to the invention, the heat treatment in the mold takes place in a manner such that although the respective layers are bonded to one another, the composite material resulting from step a) or b) is not completely cured by the heat treatment. It is therefore preferable to carry out the heat treatment in the range from 100 to 300° C., particularly preferably at from 130 to 260° C., and especially preferably at from 150 to 230° C.

A certain partial degree of curing (depending on the requirements profile) is achieved, for example, during a pressing procedure. However, it is preferable that 100% curing is not achieved until the end of the process has been reached, or after step c) of the process has been carried out, since the lower the degree of intermediate curing the more flexible the composite and/or the better its capability for shaping. The degree of curing achieved in step a) or b) is particularly preferably not more than 80%, more preferably not more than 70%, and particularly preferably not more than 60%.

In another preferred embodiment, steps a), b), and c) of the process take place simultaneously, for example by shaping the individual films simultaneously, directly in the mold, and curing these completely. This is dependent on the geometry of the mold, and also on the requirements profile for the particular molding.

For the bonding of the intermediate ply, the heat-cured layer, and, where appropriate, the outer layer made from thermoplastic, by heat treatment of these layers, use may be made of processing methods conventional in the plastics industry, such as injection molding, extrusion, thermoforming of the layers, or a heat-assisted blowing process. Molds which may be used for the process of the invention are the apparatus conventional in plastics technology, for example injection molding compartments or injection molds for injection molding, calender rolls or embossing rolls, or profile dies for extrusion, or else thermoforming molds for thermoforming, or split molds for the heat-assisted blowing process.

According to the invention, it is particularly preferable for the intermediate ply, the heat-cured layer, and, where appropriate, the outer layer made from thermoplastic to be bonded by heat treatment in a mold with exposure to pressure. Thermal pre-bonding of the layers may be carried out, for example, in a thermoforming procedure in what are known as thermoforming molds, before the final bonding (lamination) takes place with application of the backing material, e.g. by means of injection molding.

The shaping of the composite material of the invention or of the intermediate products obtained during the process may take place prior to and/or during and/or after step c).

In one embodiment preferred according to the invention, the shape is developed, or incipient or preliminary shaping takes place, prior to step a) of the process. An example of a method for this is heat treatment in a preceding operation, for example using a second mold, with the aid of a source of heat, an appropriate surface heater. This method can pre-form the individual layers three-dimensionally by heat treatment prior to the bonding in step a) of the process. As stated above, during the steps described of the process it is in principle possible for the intermediate ply to the treated, shaped, and/or partially cured at the same time as or together with the outer layer and the heat-cured layer.

In another embodiment of the present invention, preferred according to the invention, the shape is developed, or preliminary shaping takes place, during step a) or b) of the process. The design of the mold used in step a) and, where appropriate, b) for the bonding of the intermediate ply, the heat-cured layer, and, where appropriate, the outer layer made from thermoplastic is preferably such that the bonding and preliminary shaping of the layers, or development of their shape, take place simultaneously. An example of a method here for achieving three-dimensional shaping of the individual layers or plies, or else of the composite, uses the process parameters prevailing in the mold, for example, pressure and temperature. Another example of a mold suitable for simultaneous bonding and preliminary shaping of the layers, or development of their shape, is a conventional thermoforming mold.

In the thermoforming process, the layers to be three-dimensionally shaped are drawn over a thermoforming mold which has the desired three-dimensional profile, and during the process are heated in the range from 150 to 250° C., in particular from 160 to 200° C., by means of a suitable heat source, such as a surface heater. After a heating time of from about 0.1 to 2 minutes, in particular from 0.4 to 1.5 minutes, the heat source is removed and the individual layers are then drawn over the thermoforming mold, which moves upward under the effect of a vacuum. This method gives three-dimensionally shaped layers with a high level of reproduction of detail.

As stated above, step a), b), and/or c) of the process may also take place by means of extrusion. In the extrusion process it is possible, for example, to shape the layers in the form of individual films, or else together by starting with a thermoforming process, or three-dimensionally via profile extrusion, and then to heat them in a profile die to at least 180° C., preferably at least 200° C., and then to introduce them into slot-die tooling at a pressure of at least 80 N/cm², preferably at least 90 N/cm². The individual layers may also be brought into contact monolaterally or bilaterally with the thermoplastic of the carrier by way of temperature-controlled calender rolls or temperature-controlled embossing rolls (a process known as lamination) and thus bonded to one another. The three-dimensional shaping in the process of the invention may also take place within the mold, i.e. the calender rolls or embossing rolls. The temperatures set here are usually from 100 to 250° C., in particular from 150 to 210 C., the pressure set usually being from 20 to 200 N/cm², in particular from 30 to 120 N/cm². The average residence times here are from 0.1 to 10 minutes, in particular from 0.2 to 5 minutes. This method gives very good adhesion of the individual layers to one another. The resultant three-dimensional molding also has good surface properties.

The application of the thermoplastic backing layer, which preferably comprises polypropylene, provided by step c) of the process, may also use conventional processing methods, such as injection molding, extrusion, thermoforming, or a heat-assisted blowing process. The molds used may be conventional apparatus used in plastics technology, such as injection molding compartments or injection molds for injection molding, calender rolls or embossing rolls, or profile dies for extrusion, or else thermoforming molds for thermoforming, or split molds for the heat-assisted blowing process.

In one embodiment particularly preferred according to the invention, the method by which the polyolefin backing layer provided according to the invention is applied in step c) of the process to the intermediate ply or the composite obtained as intermediate is that of in-mold coating using the thermoplastic polyolefin material.

In the process known as injection molding or injection-compression molding, the composite material obtained as an intermediate, where appropriate three-dimensionally pre-formed by way of a thermoforming process, is then in-mold coated in an injection mold, using the thermoplastic polymer which forms the backing, or else is directly three-dimensionally shaped only after reaching the injection mold, and in-mold coated using the thermoplastic polymer, by an injection molding process. It is preferable for the thermoplastic backing material first to be heated to at least 150° C., in particular at least 180° C., and then introduced to the injection mold under a pressure of at least 20 N/cm², preferably at least 30 N/cm². The injection molding procedure usually takes place at from 150 to 300° C., in particular from 180 to 280° C., and at pressures of from 20 to 200 N/cm², in particular from 50 to 100 N/cm². The temperatures and pressures arising in the injection mold achieve not only a very good bond between the intermediate ply and the polyolefin backing material but also in particular a further or final complete curing of the layered composite material, which then takes the form of a three-dimensional molding. The mold is preferably cooled within from 0.1 to 5 minutes, in particular within from 0.3 to 1.2 minutes, to a temperature which can extend to 20° C., and in particular can extend to 30° C., while maintaining a hold pressure of at least 10 N/cm², in particular at least 50 N/cm², and the resultant three-dimensional molding is finally removed from the injection mold after cutting to size.

It is also possible to carry out the process of the invention for producing a three-dimensional layered composite material in a manner such that the appropriate layers are thermoformed. The three-dimensional shaping may take place here either in advance by way of an upstream thermoforming process, or else directly in the press.

The present invention also provides the use of the composite materials of the invention for producing three-dimensional moldings. The abovementioned moldings are preferably used in consumer electronics, telecommunication, the sports equipment industry, the electrical industry, the electronics industry and/or the automotive industry. In one particularly preferred embodiment, the composite materials of the invention are used for producing panel sections, keyboards, switches, instrument panels, and/or parts of the internal trim of motor vehicles.

The examples below serve for further illustration of the invention, but are not to be understood as any restriction.

### EXAMPLE 1

A polycarbonate light-scattering film (®Bayfol CR 6-2) with a thickness of 175 μm, a melamine resin film with 150% resinification and a 30 g/m² polypropylene nonwoven (®Metocene 50250—melting point 148° C.) were inserted into a 400×400 mm platen press with a platen temperature of 120° C. on both sides, and pressed using a pressure of 20 N/m². The press time was 20 sec. The degree of curing was 75%. The 75% degree of curing gave the finished pressed part, which was flat and flexible, sufficient adhesion to allow the shaping which followed. This composite was then inserted into an injection mold and directly in-mold coated using an unreinforced polypropylene, by an injection molding process, maintaining conventional injection parameters and conditions.

### EXAMPLE 2

A polycarbonate light-scattering film (®Bayfol CR 6-2) with a thickness of 175 μm was suspended in an injection mold (on the ejector side); arranged in front of this was a melamine resin film with 150% resinification and a 30 g/m² polypropylene nonowoven (®Metocene 50250—melting point 148° C.). The mold was closed and then an unreinforced polypropylene soft component (®Hifax 7320 XEP) was injected directly onto the Metocene nonwoven. The curing and the bonding of the respective layers therefore took place in a single step.

### EXAMPLE 3

A melamine film (120% resinification) and a polypropylene (®Metocene) nonwoven (30 g/m²) were pressed together for 20 s in a press (size=400×400 mm) whose temperature was 110° C. on both sides. This composite was then inserted into an injection mold and in-mold coated using a 2C injection molding process. The first component involved direct injection of a ®Bayblend T 85 (PC+ABS) onto the melamine resin surface, and the second component involved direct application of a 20% talc-reinforced polypropylene onto the Metocene nonwoven. This composite had a total thickness of about 4 mm and very good adhesion.

What is claimed is

1. A layered composite material, which encompasses
a) a polyolefin backing layer,
b) an intermediate ply arranged on the backing layer and comprising a thermoplastic polymer material,
c) a heat-cured layer arranged on the intermediate ply, and
d) an outer layer arranged on the heat-cured layer and composed of thermoplastic,
wherein the thermoplastic in the outer layer has been selected from the group consisting of polycarbonates, acrylonitrile-butadiene-styrene copolymers, polybutylene terephthalates, and polyesters, and derivatives and mixtures of the abovementioned materials.

2. The layered composite material as claimed in claim 1, wherein the polyolefin in the backing layer has been selected from the group consisting of polypropylene, polyethylene, and co- and terpolymers of ethylene, propylene, and butylene with a-olefins, and mixtures of these, and preferably comprises a homo- or copolymer of propylene.

3. The layered composite material as claimed in claim 1 or 2, wherein the backing layer comprises from 0.1 to 60% by weight, based on the total weight of the backing layer, of additives, preferably selected from the group consisting of barium sulfate, magnesium hydroxide, talc, wood, flax, chalk, glass fibers, glass beads, and soft components.

4. The layered composite material as claimed in one or more of the preceding claims, wherein the intermediate ply arranged on the backing layer comprises a thermoplastic polymer material, preferably a polymer material selected from the group consisting of polypropylene, polyethylene, polymers of styrene, polyoxymethylene, and polybutylene terephthalate, more preferably a polypropylene, and particularly preferably a polypropylene with a melting point below 165° C.

5. The layered composite material as claimed in one or more of the preceding claims, wherein the intermediate ply arranged on the backing layer encompasses a resin-saturated paper, nonwoven, fabric made from thermoplastic, or a film made from thermoplastic.

6. The layered composite material as claimed in one or more of the preceding claims, wherein the heat-cured layer comprises a thermoset material which is crosslinked by the action of pressure or heat during the production of the layered composite material.

7. The layered composite material as claimed in one or more of the preceding claims, wherein the heat-cured layer comprises resin, preferably acrylate resin, phenolic resin, urea resin and/or melamine resin.

8. The layered composite material as claimed in one or more of the preceding claims, wherein the outer layer arranged on the heat-cured layer and made from thermoplastic is a thermoplastic film, preferably a printed, colored and/or otherwise decorated film.

9. The layered composite material as claimed in one or more of the preceding claims, wherein the outer layer arranged on the heat-cured layer and made from thermoplastic is a polycarbonate film, preferably a polyarbonate film with a thickness in the range from 50 to 800 μm, particularly preferably from 100 to 400 μm.

10. The layered composite material as claimed in one or more of the preceding claims, wherein the total thickness of the layered composite is in the range from 1 to 100 mm, at least 80% of the total thickness preferably being provided by the backing layer.

11. A process for producing a layered composite material as claimed in any of claims 1 to 10, which comprises:
a) bonding a heat-curable or at least partially heat-cured layer and an intermediate ply by heat treatment of these layers in a mold,
b) applying an outer layer made from thermoplastic,
c) applying a polyolefin backing layer to the intermediate ply,
the steps a), b) and/or c) taking place simultaneously or in succession, where the three-dimensional shaping takes place prior to and/or during and/or after step c).

12. The process as claimed in claim 11, wherein each of the materials for the intermediate ply, the heat-cured layer, and, where appropriate, the outer layer is brought to the process in the form of a sheet, and these are then bonded to one another at temperatures in the range from 150 to 300° C., the resultant degree of curing being not more than 80%, preferably not more than 70%, and particularly preferably not more than 60%.

13. The process as claimed in claim 11 or 12, wherein the layered composite material is three-dimensionally shaped at temperatures in the range from 150° C. to 300° C.

14. The process as claimed in one or more of claims 11 to 13, wherein injection molding is used to apply the outer layer and/or the polyolefin backing layer.

15. The use of a layered composite material as claimed in one or more of claims 1 to 10 for producing three-dimensional moldings, preferably for producing moldings in the electrical, construction, or automotive industry, with very good reproduction of detail and with excellent surface properties, and particularly preferably for producing panel secions, keyboards, switches, instrument panels, and/or parts of the internal trim of motor vehicles.
